(19) United States
(12) Patent Application Publication
(10) Pub. No.: US 2014/0234472 A1
(43) Pub. Date: Aug. 21, 2014

(54) CLOSING UNIT OF AN INJECTION MOLDING MACHINE

(71) Applicant: ENGEL AUSTRIA GmbH, Schwertberg (AT)

(72) Inventor: Stephan EPPICH, Arbing (AT)

(73) Assignee: ENGEL AUSTRIA GmbH, Schwertberg (AT)

(21) Appl. No.: 14/176,336

(22) Filed: Feb. 10, 2014

(30) Foreign Application Priority Data
Feb. 19, 2013 (AT) 126/2013

(51) Int. Cl. B29C 45/64; B29C 45/17

(52) U.S. Cl. CPC B29C 45/64; B29C 45/1744
USPC 425/592; 425/589

(57) ABSTRACT

A closure unit of an injection molding machine has a fixed mold mounting plate, a moveable mold mounting plate, and at least one mounting element for mounting the fixed mold mounting plate to a machine frame. The at least one mounting element upon accelerations and decelerations of the moveable mold mounting plate to reach the closed position allows such movements of the fixed mold mounting plate relative to the machine frame that rotations and/or movements transversely relative to a machine axis of the fixed mold mounting plate relative to the moveable mold mounting plate are substantially prevented.

The invention concerns a closure unit of an injection molding machine having the feature of the classifying portion of claim 1.

In general acceleration and deceleration of the moveable mold mounting plate give rise to unwanted movements—in particular inclination movements and vibration—of the moveable mold mounting plate, the fixed mold mounting plate and possibly the end plate. Particularly when there are frame bars those inclination movements and vibrations are also transmitted from the various plates to each other. Upon deceleration of the moveable mold mounting plate that is particularly harmful as when the two tool halves meet wear and tear going as far as actual damage can be the result due to non-parallelism situations. A further problem arises in manufacture of components which require a very high level of precision. For example the above-mentioned plate inclinations result in a displacement so that the two tool halves are no longer placed exactly one upon the other. Particularly with optical components like for example small lenses that can result in a high reject rate.

That mechanism is particularly amplified in the case of horizontal closure units having four frame bars and an elbow lever mechanism. Inclination of the end plate, which is produced upon deceleration of the moveable mold mounting plate and—transmitted by the frame bars—of the fixed mold mounting plate is also adapted by the moveable mold mounting plate. The reason for this is the application of force in off-center relationship with the axis of the machine.

To minimize the effects of inclinations and vibration on the injection molded product or the reject level as much as possible it only remains for the closing movement to be implemented more slowly, which naturally has a detrimental effect on the cycle time.

The problem of plate parallelism is the theme of many patent publications. As examples mention should be made of EP 1 837 153 A1 or JP 4-135705. In those specifications the attempt to resolve the problem by means of inclination adjustment of the fixed mold mounting plate.

A further closure unit which is intended to offer very good plate parallelism is known from EP 1 726 425 A1. A frame structure which is extended upwardly at the sides is intended to provide a better mounting effect and in particular good parallelism of the plates even under the pressing pressure of an injection nozzle. As an extremely high level of material involvement is necessary for that purpose, that has a great deal of room for improvement.

A disadvantage with all those kinds of structure is that plate parallelism is admittedly in part improved, but the displacement which occurs due to simultaneous inclination of the moveable and the fixed mold mounting plate is not corrected. In addition the vibrations caused by the acceleration of the moveable mold mounting plate are transmitted directly between the machine frame and the fixed mold mounting plate.

Closure units as are known for example from WO 96/11785 are not of the same general kind as this invention. Admittedly in this case also mold mounting plates are flexibly supported. That however serves to maintain plate parallelism under the closing force. The movements and forces which occur here are therefore entirely different from those involved in the movement of the moveable mold mounting plate to achieve the closed position.

The object of the invention is to provide a closure unit which is distinguished by a simple structure, improved plate parallelism, a low level of transmission of vibration and suitability for precision injection molding by avoiding a displacement between plate centers due to acceleration of the moveable mold mounting plate.

That object is attained by a closure unit having the features of claim 1.

That is effected in that the at least one mounting element upon accelerations and decelerations of the moveable mold mounting plate to reach the closed position allows such movements of the fixed mold mounting plate relative to the machine frame that rotations and/or or movements transversely relative to a machine axis of the fixed mold mounting plate relative to the moveable mold mounting plate are substantially prevented. During the closing movement therefore the reference position of the fixed mold mounting plate is to be observed as accurately as possible by decoupling of the fixed mold mounting plate from the machine frame.

Further advantageous embodiments of the invention are recited in the appendant claims.

Particularly for precision injection of optical components it is preferably provided that upon acceleration of the moveable mold mounting plate for reaching the closed position the at least one mounting element allows such movement of the fixed mold mounting plate relative to the machine frame that inclinations of the fixed mold mounting plate are at least reduced. In other words the fixed mold mounting plate is so mounted that upon accelerations of the moveable mold mounting plate the forces acting thereby on the fixed mold mounting plate are not translated into an inclination movement of the fixed mold mounting plate but into a movement along the machine axis. As therefore the movement of the moveable mold mounting plate is converted into harmless movements along the machine axis that represents a considerable improvement.

In a particularly effective manner compensation of inclinations and vibration can be implemented by the at least one mounting element allowing movements of the fixed mold mounting plate substantially along a machine axis.

To be able to better suppress inclination movements it can be provided that the at least one mounting element has at least one elastic zone.

Simple mounting of the fixed mold mounting plate can be achieved by the provision of precisely two mounting elements.

In order to substantially decouple the movements of the fixed mold mounting plate and the machine frame relative to each other it can be provided that there is a clearance between the fixed mold mounting plate and the machine frame.

In a particularly simple structural configuration the mounting system can be provided by the at least one mounting element being fixed to sides of the fixed mold mounting plate.

To utilize lever ratios as well as possible upon acceleration of the moveable mold mounting plate it is preferably provided that the at least one mounting element is fixed to the fixed mold mounting plate above a plate center of the fixed mold mounting plate. That applies in particular in relation to a closure unit having four frame bars for the fact that the closure drive acts substantially on the axis of the machine and the moveable mold mounting plate and optionally the end plate are mounted to the machine frame affords a greater movement for the upper part of the fixed mold mounting plate and optionally for the upper frame members. By virtue of the placement of the fixing point over the machine axis therefore the lever arm for those movements is shortened in the upper part of the fixed mold mounting plate and naturally the lever arm for the movements of the lower portion of the fixed mounting plate is increased in length.

In a preferred embodiment of the invention it is provided that the at least one mounting element is of a trapezoidal—preferably parallelogram-shaped—configuration. That structure represents a particularly inexpensive arrangement because it saves on material.

Further advantages and details of the invention will be apparent from the Figures and the related specific description. In the Figures:

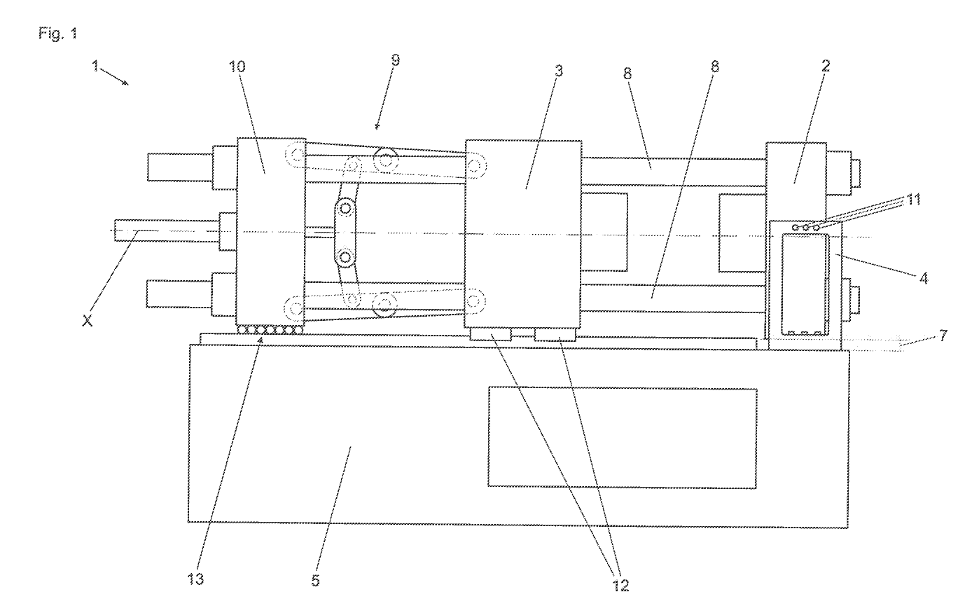

FIG. 1 shows a side view of a closure unit according to the invention,

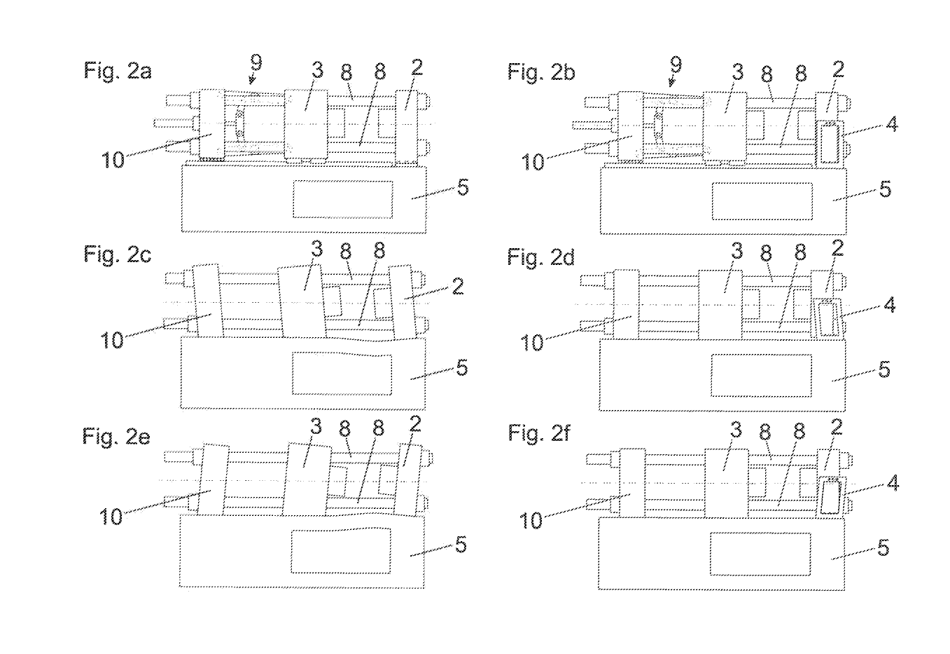

FIGS. 2a through 2f show an illustration of the operative principle or operative difference between closure units from the state of the art and closure units according to the invention,

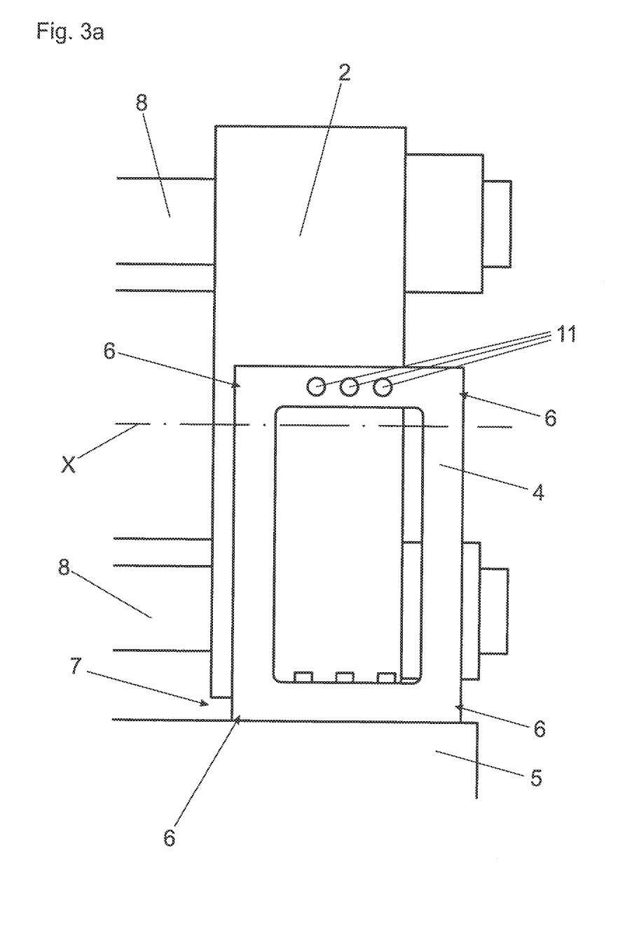

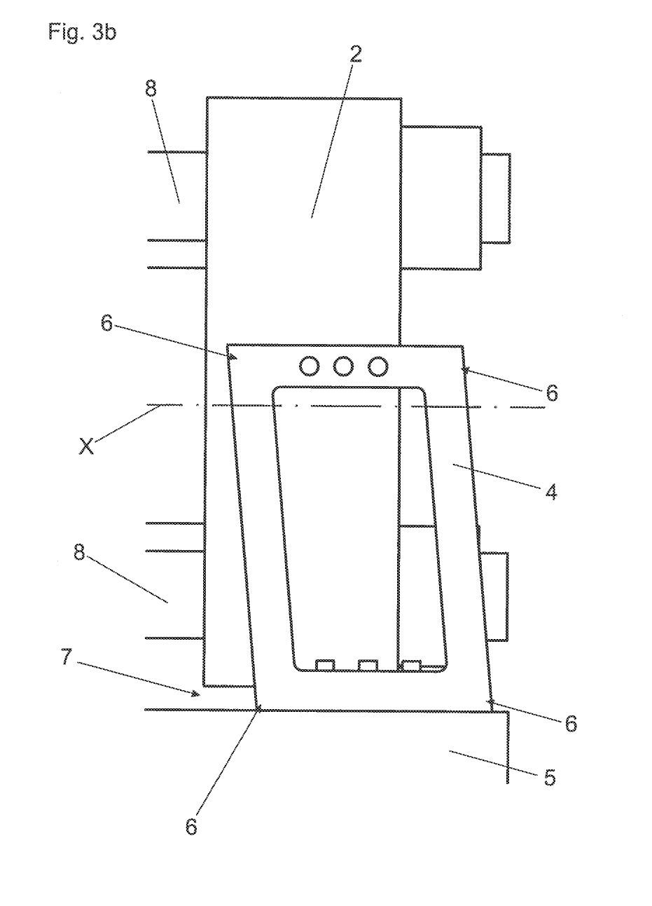

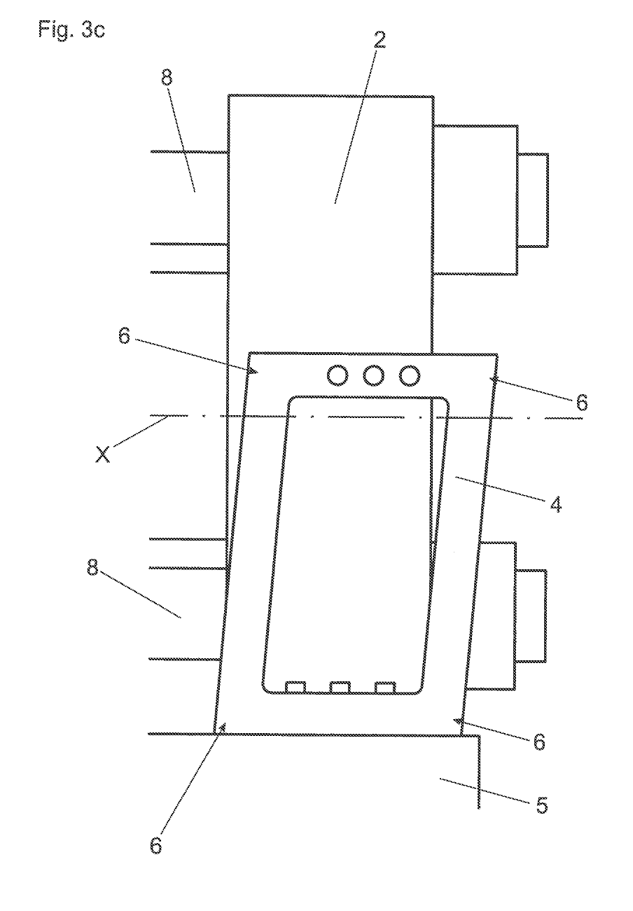

FIGS. 3a through 3c show side views of a mounting according to the invention for a fixed mold mounting plate in three different acceleration conditions,

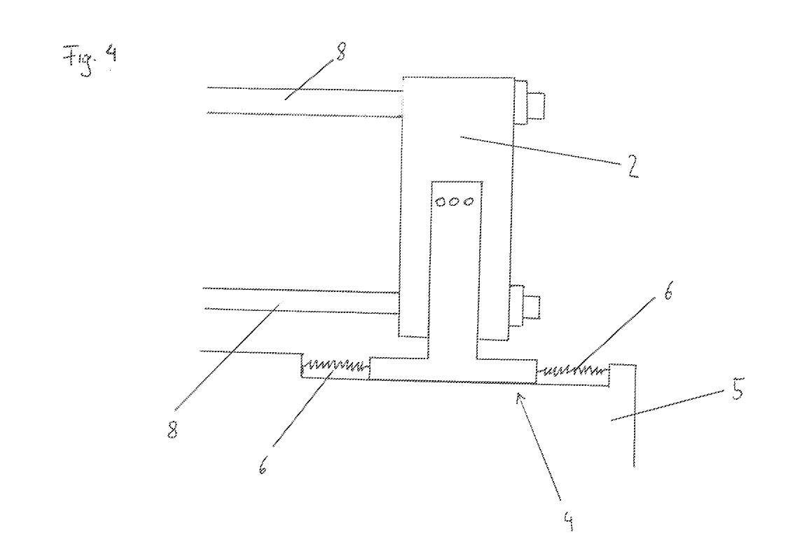

FIG. 4 shows a further embodiment of the invention, and

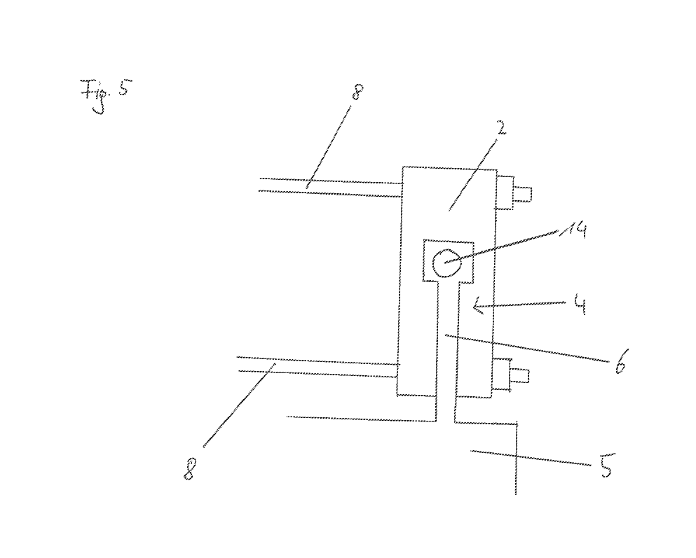

FIG. 5 shows a further embodiment of the invention.

The closure unit 1 shown in FIG. 1 has an elbow lever mechanism 9 and four frame bars 8 (as this is a side view only two frame bars 8 are visible). Both the end plate 10 and also the moveable mold mounting plate 3 are slidingly mounted, in which respect a linear guide 12 for the moveable mold mounting plate 3 and rollers 13 for the end plate 10 are shown here only by way of example.

The fixed mold mounting plate 2 is mounted by way of the mounting element 4, wherein the fixing between the mounting element and the fixed mold mounting plate is implemented by way of three respective fixing bolts 11. That mounting is above the machine axis X, which is optimum for suppression of inclination and thus displacement between the tool halves upon acceleration of the moveable mold mounting plate. The fixing element 4 is fixed to the machine frame 5 by way of screws.

A clearance 7 between the fixed mold mounting plate 2 and the machine frame 5 ensures that the fixed mold mounting plate 2 is supported only by way of the mounting element 4. In that way the mounting arrangement which admittedly allows movements along the machine axis X but suppresses inclinations of the fixed mold mounting plate can deploy its full action.

The mode of operation of the mounting arrangement is now described in greater detail with reference to FIG. 2a through 2f.

FIG. 2a shows a horizontal closure unit from the state of the art, while FIG. 2b shows a unit according to the invention. It is only in those two Figures that the elbow lever mechanism 9, the linear guide 12 and the rollers 13 for slidingly mounting the moveable mold mounting plate 3 as well as the end plate 10 are shown. They are naturally also present in FIGS. 2c through 2f but are not shown for the sake of clarity.

FIG. 2c shows a horizontal closure unit of the state of the art upon acceleration of the moveable mold mounting plate 3. The end plate 10 is caused to incline towards the left by the elbow lever mechanism, and that is also transmitted to the fixed mold mounting plate 2 by way of the frame bars 8. In addition the elbow lever mechanism 9 provides that the moveable mold mounting plate 3 also experiences inclination towards the left. If a hydraulic ram were used here as the drive then the moveable mold mounting plate would be inclined towards the right upon acceleration, by virtue of the modified kinematics. It is also possible to see the deformation of the machine frame 5 due to the inclination of the fixed mold mounting plate 2. Those vibrations which in that way are transmitted to the machine frame 5 are naturally also not advantageous.

FIG. 2d now shows a closure unit according to the invention upon acceleration of the moveable mold mounting plate 3. Because the fixed mold mounting plate allows a slight movement towards the left without at the same time having to experience an inclination movement, the inclinations of the end plate 10 and the moveable mold mounting plate and naturally the fixed mold mounting plate 2 are almost completely suppressed. That is effected, as mentioned, by a small compensation movement of the fixed mold mounting plate 2. It is also important that both the end plate 10 and also the moveable mold mounting plate 3 are slidingly mounted.

Similarly to FIG. 2c FIG. 2e shows a closure unit of the state of the art upon deceleration of the moveable mold mounting plate 3. This involves an inclination of the end plate 10 towards the right, and that is also again transmitted to the fixed mold mounting plate 2 by way of the frame bars 8. In addition the elbow lever mechanism again provides that the moveable mold mounting plate 3 is also inclined towards the right. Naturally vibration is also again transmitted to the machine frame by the fixed mold mounting plate.

Both FIG. 2c and also FIG. 2e clearly show the displacement produced by the inclinations of the fixed mold mounting plate 2 and the moveable mold mounting plate 3.

FIG. 2f now shows the behavior of a closure unit according to the invention upon deceleration of the moveable mold mounting plate 3. The mounting element 4 allows the fixed mold mounting plate to perform a small compensation movement towards the right without at the same time forcing an inclination towards the right of the fixed mold mounting plate 2. As a result the end plate 10 also remains upright. The same applies to the moveable mold mounting plate 3, by means of the elbow lever mechanism 9. Vibration is transmitted to the machine frame 5 neither in the situation in FIG. 2d nor in the situation in FIG. 2f.

In addition there is also no displacement between the tool halves.

FIGS. 3a through 3c now show the mounting arrangement in the conditions illustrated in FIGS. 2b, 2d and 2f respectively. The clearance 7 can also be clearly seen here. In this embodiment with a parallelogram as the mounting element 4 the elastic zones 6 are respectively disposed at the corners of the parallelogram. Upon acceleration (FIG. 3b) and upon braking (FIG. 3c) they allow the parallelogram a displacement along the machine axis X at the top side, the underside of the parallelogram remaining fixed at the machine frame 5.

FIG. 4 shows a further embodiment of the invention. The mounting element has a T-shaped carrier, wherein the wide side bears at the bottom against the machine frame to prevent inclinations. The elastic regions 6 are here in the form of two spring elements by which slight movements are made possible along the machine axis X.

FIG. 5 also shows a further embodiment. Here the mounting element is in the form an upright holding bar, at the top side of which the fixed mold mounting plate is supported by way of a joint 14. The upright holding bar in that case itself forms the elastic region 6. The joint 14 ensures that upon elastic deformation of the upright holding bar, no moment working towards inclination of the fixed mold mounting plate occurs.

The present invention is not limited to the embodiments illustrated here. For example the invention can equally well be used in horizontal closure units having a hydraulic ram instead of an elbow lever mechanism.

1. A closure unit of an injection molding machine having a fixed mold mounting plate, a moveable mold mounting plate and at least one mounting element for mounting the fixed mold mounting plate to a machine frame, wherein the at least one mounting element upon accelerations and decelerations of the moveable mold mounting plate to reach the closed position allows such movements of the fixed mold mounting plate relative to the machine frame that rotations and/or movements transversely relative to a machine axis of the fixed mold mounting plate relative to the moveable mold mounting plate are substantially prevented.

2. A horizontally closing closure unit as set forth in claim 1, wherein the at least one mounting element allows such movement of the fixed mold mounting plate relative to the machine frame that inclinations of the fixed mold mounting plate, that occur upon accelerations and decelerations of the moveable mold mounting plate to reach the closed position, are substantially prevented.

3. A closure unit as set forth in claim 1, wherein the at least one mounting element allows movements of the fixed mold mounting plate substantially along a machine axis.

4. A closure unit as set forth in claim 1, wherein the at least one mounting element has at least one elastic zone.

5. A closure unit as set forth in claim 1, wherein there are provided precisely two mounting elements for mounting the fixed mold mounting plate.

6. A closure unit as set forth in claim 1, wherein there is a clearance between the fixed mold mounting plate and the machine frame.

7. A closure unit as set forth in claim 1, wherein the at least one mounting element is fixed at sides of the fixed mold mounting plate.

8. A closure unit as set forth in claim 1, wherein the at least one mounting element is fixed to the fixed mold mounting plate above a plate center of the fixed mold mounting plate.

9. A closure unit as set forth in claim 1, wherein the at least one mounting element is of a trapezoidal—preferably parallelogram-shaped—configuration.

10. A closure unit as set forth in claim 1, wherein the closure unit has four frame bars which pass through the moveable mold mounting plate and the fixed mold mounting plate.

11. A closure unit as set forth in claim 1, wherein the closure unit has an elbow lever mechanism.

12. A closure as set forth in claim 1, wherein the closure unit is in the form of a horizontally closing closure unit.
